(19) United States
(12) Patent Application Publication
(10) Pub. No.: US 2014/0348368 A1
(43) Pub. Date: Nov. 27, 2014

(54) HOUSING ASSEMBLY AND ELECTRONIC DEVICE USING THE SAME

(71) Applicant: CHIUN MAI COMMUNICATION SYSTEMS, INC., New Taipei (TW)

(72) Inventors: CHIEN-FENG YEH, New Taipei (TW); WEI-JEN CHANG, New Taipei (TW); MENG-JER HUANG, New Taipei (TW); CHIH-WEI SU, New Taipei (TW); CHUN-YEN LIU, New Taipei (TW); CHIH-CHENG CHANG, New Taipei (TW)

(73) Assignee: CHIUN MAI COMMUNICATION SYSTEMS, INC., New Taipei (TW)

(21) Appl. No.: 14/014,600

(22) Filed: Aug. 30, 2013

(30) Foreign Application Priority Data
May 23, 2013 (TW) 102209544

(51) Int. Cl. H04R 1/02

(52) U.S. Cl. CPC H04R 1/02
USPC 381/334; 312/223.4

(57) ABSTRACT

A housing assembly of an electronic device includes an outer housing, an inner housing mounted to the outer housing, a first waterproof film positioned between the outer housing and the inner housing, and a second waterproof film spaced from the first waterproof film. The first waterproof film, the outer housing, and the inner housing cooperatively define a first cavity of the housing assembly. The second waterproof film, the inner housing, and the first waterproof film cooperatively form a second cavity of the housing assembly. The first and second waterproof films provide the housing assembly an excellent waterproof property. The electronic device using the housing assembly is also described.

### BACKGROUND

1. Technical Field

The present disclosure generally relates to housing assemblies, and particularly to a housing assembly having excellent waterproof property and an electronic device using the housing assembly.

2. Description of Related Art

Electronic devices (such as mobile phones and personal digital assistants) include loudspeakers. Many loudspeakers have an IP67 (Ingress Protection Rating, 6 is a level of protection for solid, 7 is a level of protection for liquid) waterproof film attached to prevent water and/or oil from entering the loudspeaker. However, the IP67 waterproof film is not enough to prevent large amounts of water from penetrating the loudspeaker. Furthermore, the IP67 waterproof film has high acoustic impedance, which reduces a quality of the sound emitted by the loudspeaker.

Therefore, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an electronic device in accordance with an exemplary embodiment.

FIG. 2 is an exploded view of the electronic device of FIG. 1.

FIG. 3 is an enlarged view of portion III as shown in FIG. 2.

FIG. 4 is another exploded view of the electronic device of FIG. 1.

FIG. 5 is an enlarged view of portion V as shown in FIG. 4.

FIG. 6 is an enlarged view of portion VI as shown in FIG. 4.

FIG. 7 is a cross-sectional view of the electronic device of FIG. 1 along line VII-VII.

FIG. 8 is a cross-sectional view of the electronic device of FIG. 1 along line VIII-VIII.

### DETAILED DESCRIPTION

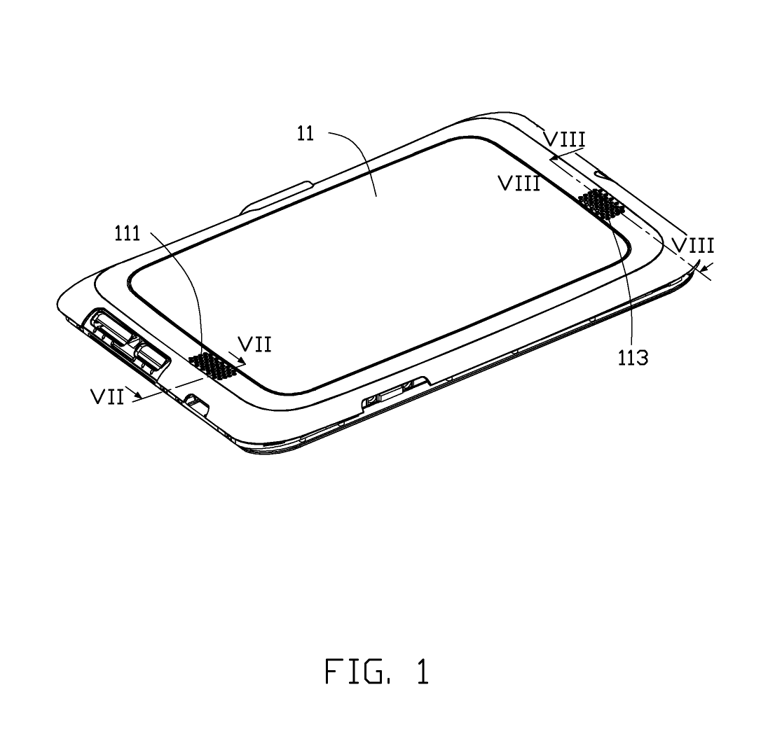

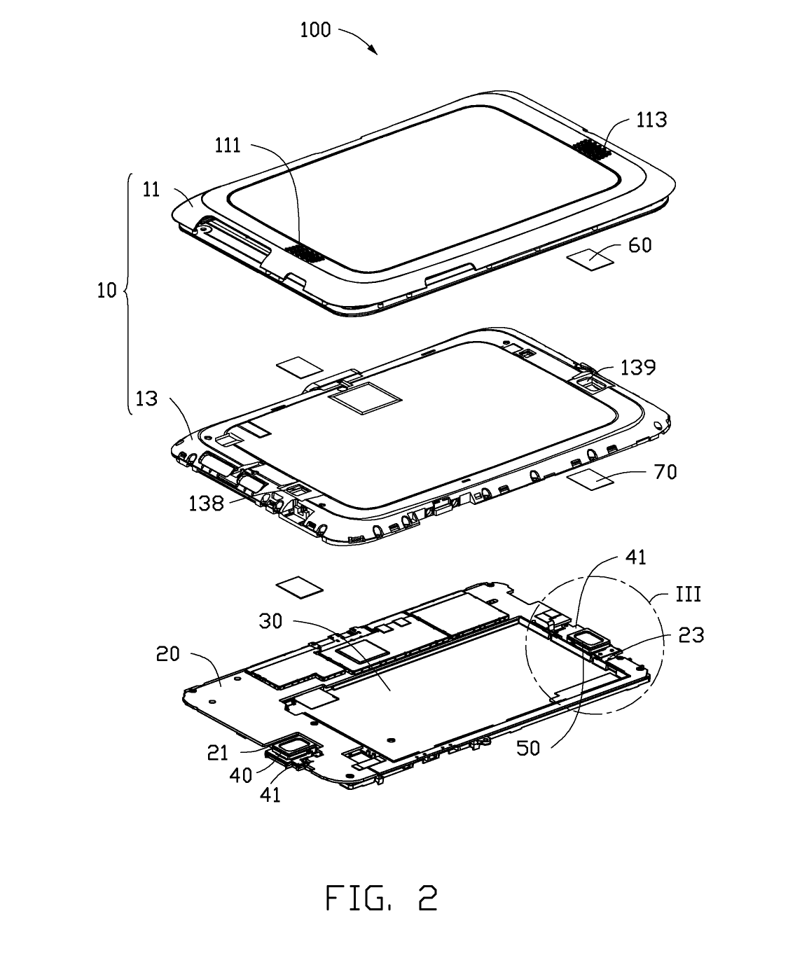

FIGS. 1-2 show an exemplary embodiment of an electronic device 100 (i.e., a mobile phone) for describing the disclosure. The electronic device 100 includes a housing assembly 10, a circuit board 20, a mounting member 30, a first loudspeaker 40, a second loudspeaker 50, at least one first waterproof film 60, and at least one second waterproof film 70. The circuit board 20 is caught between the housing assembly 10 and the mounting member 30. The first loudspeaker 40 and the second loudspeaker 50 are mounted on the mounting member 30 and are received in the housing assembly 10. The first loudspeaker 40 is positioned at one end of the circuit board 20, while the second loudspeaker 50 is positioned at another end of the circuit board 20. In the exemplary embodiment, there are two first waterproof films 60 and two second waterproof films 70, all of which are received in the housing assembly 10.

The housing assembly 10 may be a rear cover, for example, of the electronic device 100. The electronic device 100 may further include a front cover (not shown) to match the housing assembly 10, and a battery (not shown) connected to the circuit board 20 to power the electronic device 100.

The housing assembly 10 includes an outer housing 11 and an inner housing 13 mounted to the outer housing 11. The outer housing 11 defines a plurality of first sound holes 111 and a plurality of second sound holes 113. The first sound holes 111 are defined at one end of the outer housing 11, while the second sound holes 113 are defined at another end of the outer housing 11. The first sound holes 111 and the second sound holes 113 allow the sounds emitted by the first loudspeaker 40 and the second loudspeaker 50, respectively to transmit to the outside of the housing assembly 10.

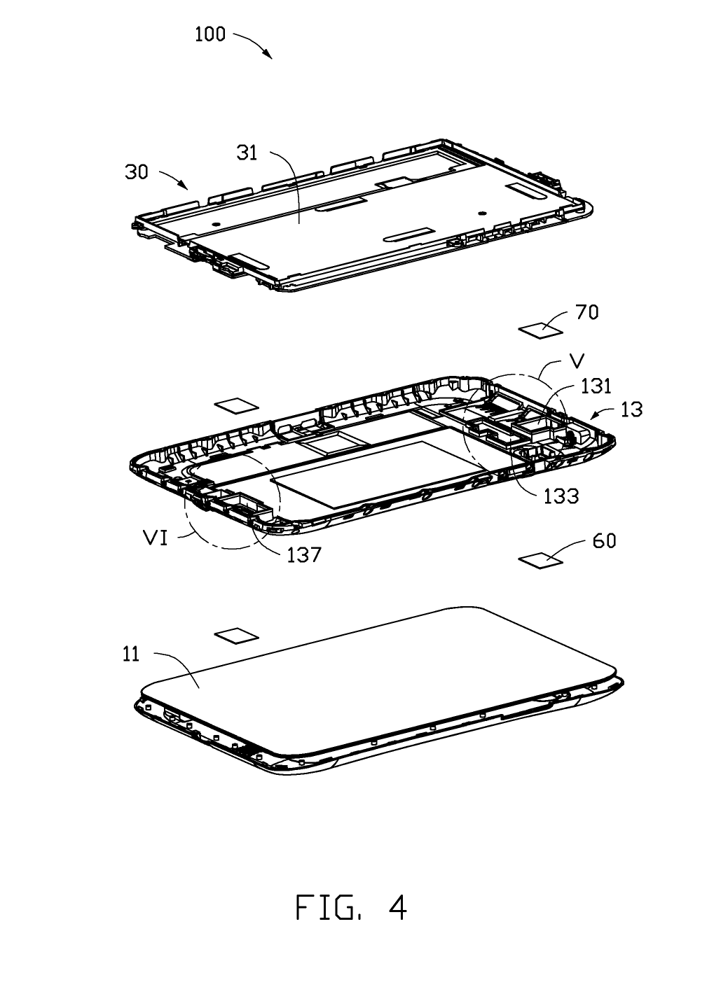

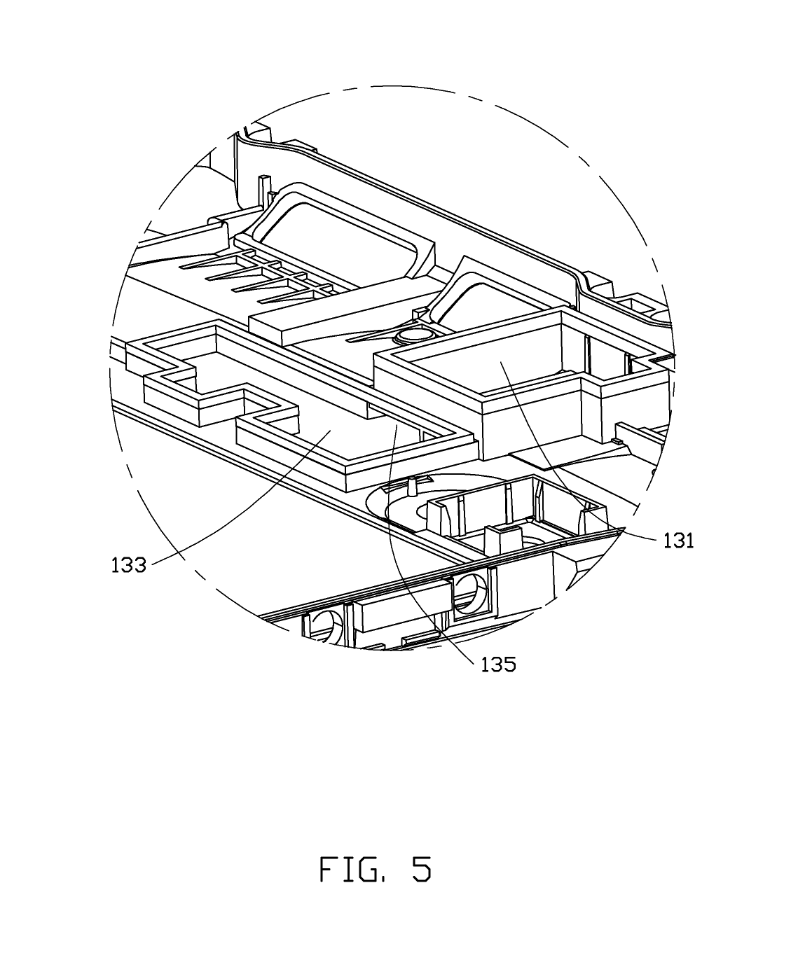

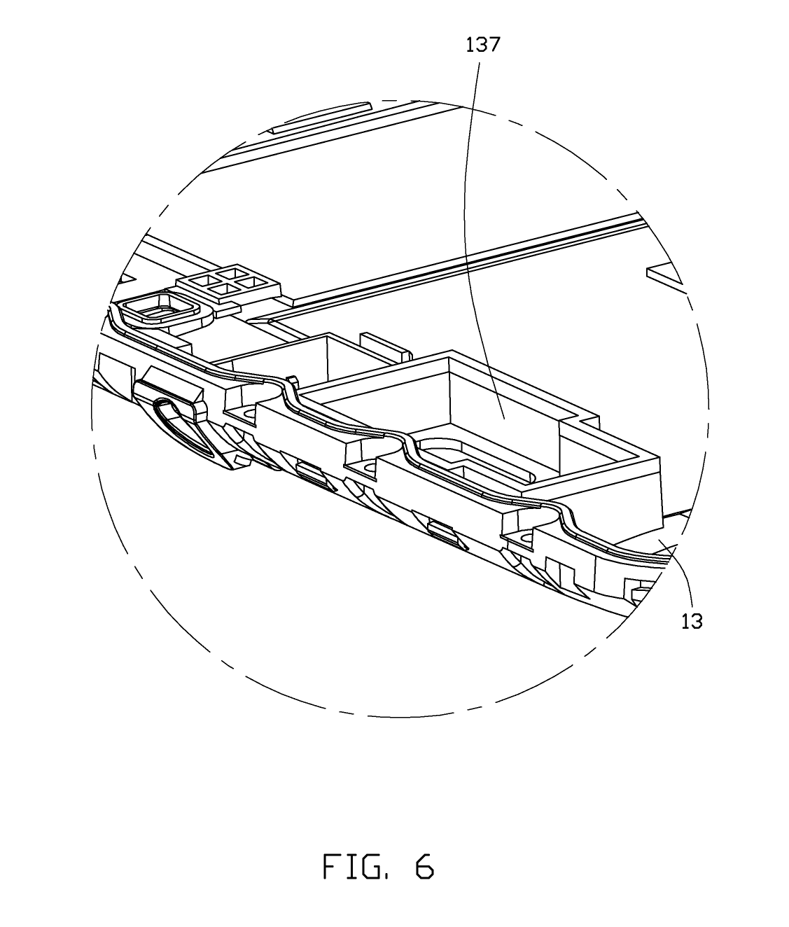

Also referring to FIGS. 4-8, the inner housing 13 defines at one end of the inner housing 13 a first receiving chamber 131 and a second receiving chamber 133 adjacent to the first receiving chamber 131. The first receiving chamber 131 and the second receiving chamber 133 communicate with each other via a first through hole 135. The first receiving chamber 131 communicates with the first sound holes 111. The inner housing 13 also defines a third receiving chamber 137 at another end of the inner housing 13. The third receiving chamber 137 communicates with the plurality of second sound holes 113.

Referring to FIGS. 2 and 5-8, two first shoulders 138 protrude from two sidewalls of the first receiving chamber 131. The first shoulders 138 are positioned between the first sound holes 111 and the first loudspeaker 40. Two second shoulders 139 protrude from two sidewalls of the third receiving chamber 137. The second shoulders 139 are positioned between the second sound holes 113 and the second loudspeaker 50.

The circuit board 20 defines a first opening 21 at one end, and a second opening 23 at another end. The first opening 21 corresponds to the first receiving chamber 131 and the first sound holes 111, and the second opening 23 corresponds to the third receiving chamber 137 and the second sound holes 113. The first loudspeaker 40 is received in the first opening 21, and the second loudspeaker 50 is received in the second opening 23.

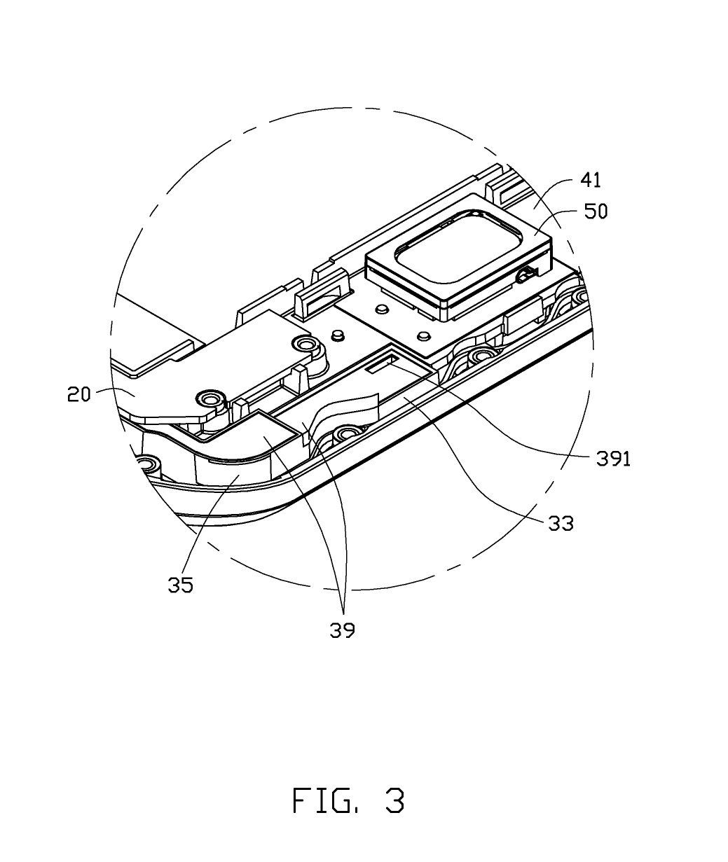

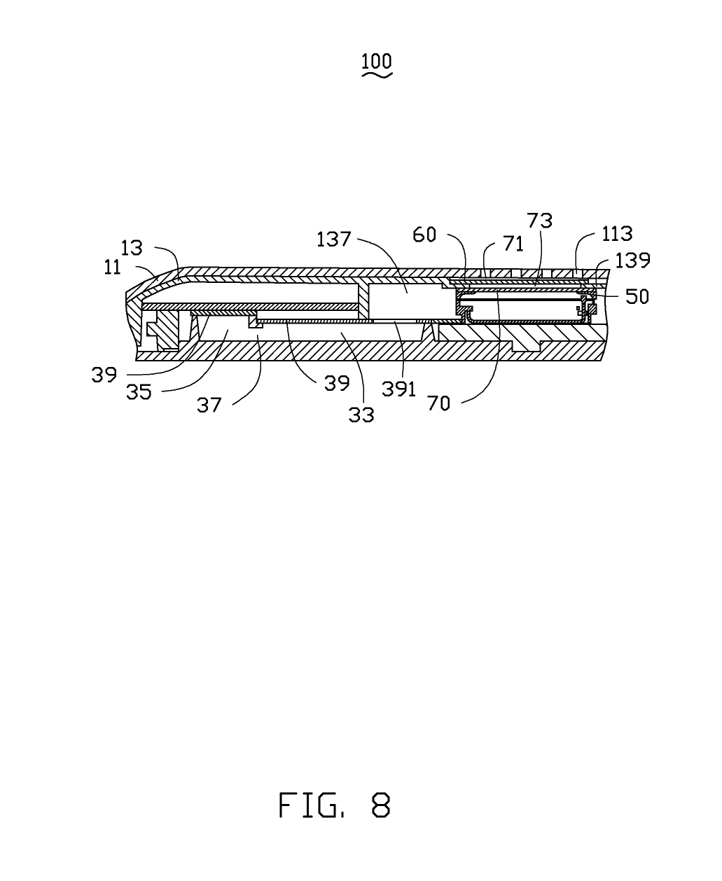

Referring to FIGS. 3, 4 and 8, the mounting member 30 includes a bottom wall 31, a first chamber 33 near the second opening 23 of the circuit board 20, and a second chamber 35 adjacent to the first chamber 33. The circuit board 20 is supported by the bottom wall 31. The first chamber 33 and the second chamber 35 communicate via a second through hole 37 (see FIG. 8). The first chamber 33 and the second chamber 35 are each covered by a plate 39. The plates 39 seal the first chamber 33 and the second chamber 35. The plate 39 covering the first chamber 33 defines a third through hole 391. The first chamber 33 and the third receiving chamber 137 communicate via the third through hole 391 (see FIG. 8).

Referring to FIGS. 2 and 3, the first loudspeaker 40 and the second loudspeaker 50 are mounted on the bottom wall 31 of the mounting member 30 via a mounting base 41, which electrically connects the first loudspeaker 40 and the second loudspeaker 50 to the circuit board 20.

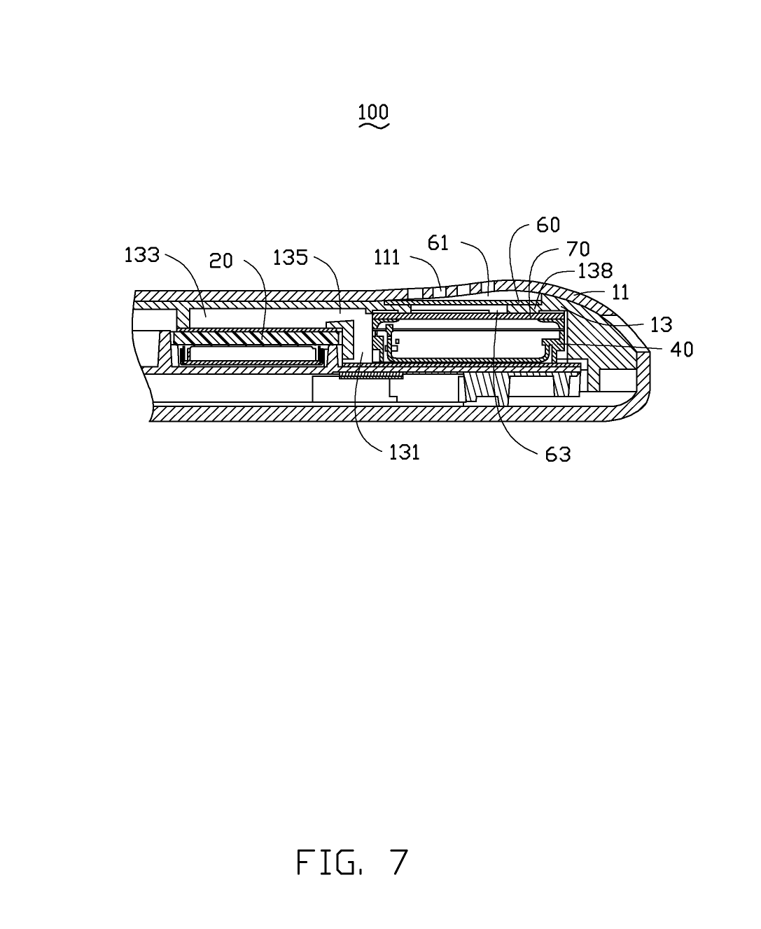

Referring to FIG. 7, one first waterproof film 60 is attached or adhered on the two first shoulders 138. The first waterproof film 60 is positioned between the first shoulders 138 and the outer housing 11, and defines a first cavity 61 with the outer housing 11. One second waterproof film 70 is attached or adhered to the first loudspeaker 40. The second waterproof film 70 is positioned between the first loudspeaker 40 and the two first shoulders 138, and defines a second cavity 63 with the first waterproof film 60 and the first shoulders 138.

Referring to FIG. 8, another first waterproof film 60 is attached or adhered on the two second shoulders 139. The first waterproof film 60 is positioned between the second shoulders 139 and the outer housing 11, and defines a third cavity 71 with the outer housing 11. Another second waterproof film 70 is attached or adhered to the second loudspeaker 50. The second waterproof film 70 is positioned between the second loudspeaker 50 and the two second shoulders 139, and defines a fourth cavity 73 with the first waterproof film 60 and the second shoulders 139.

The waterproof films 60 and 70 are made of synthetic resins or tarp (IP54, for example), which defines a plurality of micro-pores therein (not shown). The waterproof films 60 and 70 protect the loudspeakers 40 and 50 from damage by water, without reducing the quality of the sound. Since there are two waterproof films for each loudspeaker, the waterproof property of the loudspeakers 40 and 50 is enhanced. Even if water manages to penetrate the first waterproof films 60 to enter in the second cavity 63 and the fourth cavity 73, the water cannot penetrate the second waterproof films 70. Furthermore, when the first and second loudspeakers 40 and 50 are turned on, water in the second cavity 63 and the fourth cavity 73 is discharged out of the outer housing 11 by the vibration of the first and second loudspeakers 40 and 50.

During assembly of the electronic device 100, the circuit board 20 is mounted to the bottom wall 31 of the mounting member 30. The two mounting bases 41 are mounted on the bottom wall 31 of the mounting member 30 at a location corresponding to the first opening 21 and the second opening 23, respectively, and are electrically connected to the circuit board 20. The first loudspeaker 40 covered by one second waterproof film 70 and the second loudspeaker 50 covered by another second waterproof film 70 are respectively mounted to one of the mounting bases 41. One first waterproof film 60 is adhered to the first shoulders 138, and another first waterproof film 60 is adhered to the second shoulders 139. The inner housing 13 is engaged with the outer housing 11 to form the housing assembly 10. Then, the housing assembly 10 is engaged with the mounting member 30. As such, the first loudspeaker 40 is received in the first receiving chamber 131, and the second loudspeaker 50 is received in the third receiving chamber 137.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A housing assembly, comprising:
an outer housing;
an inner housing mounted to the outer housing;
a first waterproof film positioned between the outer housing and the inner housing to define a first cavity with the outer housing and the inner housing; and
a second waterproof film spaced from the first waterproof film , the second waterproof film, the inner housing, and the first waterproof film cooperatively forming a second cavity.

2. The housing assembly as claimed in claim 1, wherein the outer housing defines a plurality of first sound holes at one end of the outer housing, the inner housing defines a first receiving chamber at one end of the inner housing, towards the outer housing and communicating with the plurality of first sound holes.

3. The housing assembly as claimed in claim 2, wherein two first shoulders protrude from two sidewalls of the first receiving chamber, the first waterproof film is attached on the first shoulders and faces the first sound holes, the first waterproof film is positioned between the first shoulders and the outer housing so as to define the first cavity.

4. The housing assembly as claimed in claim 2, wherein the outer housing defines a plurality of second sound holes at another end of the outer housing, the inner housing defines a third receiving chamber at another end of the inner housing, towards the outer housing and communicating with the plurality of second sound holes, two second shoulders protrude from two sidewalls of the third receiving chamber facing the second sound holes.

5. The housing assembly as claimed in claim 4, wherein the housing assembly comprises another first waterproof film corresponding to the second sound holes, the another first waterproof film is attached on the second shoulders and faces the second sound holes, the another first waterproof film is positioned between the second shoulders and the outer housing so as to define a third cavity.

6. The housing assembly as claimed in claim 5, wherein the housing assembly comprises another second waterproof film facing the another first waterproof film, the another first waterproof film, the second shoulders, and the another second waterproof film cooperatively to form a fourth cavity.

7. The housing assembly as claimed in claim 6, wherein the first and second waterproof films are made of synthetic resin or tarp, the first and second waterproof films define a plurality of micro-pores therein.

8. An electronic device, comprising:
a housing assembly comprising an outer housing, an inner housing mounted to the outer housing, and a first waterproof film positioned between the outer housing and the inner housing to define a first cavity with the outer housing and the inner housing;
a first loudspeaker received in the housing assembly; and
a second waterproof film spaced from the first waterproof film and positioning between the inner housing and the first loudspeaker, the second waterproof film, the inner housing, and the first waterproof film cooperatively forming a second cavity.

9. The electronic device as claimed in claim 8, wherein the outer housing defines a plurality of first sound holes at one end of the outer housing, the first waterproof film faces the first sound holes, the second waterproof film is attached on the first loudspeaker, towards the first sound holes.

10. The electronic device as claimed in claim 8, wherein the outer housing defines a plurality of second sound holes at another end of the outer housing, the electronic device comprises another first waterproof film corresponding to the second sound holes, the another first waterproof film faces the second sound holes, the another first waterproof film is positioned between the inner housing and the outer housing so as to define a third cavity.

11. The electronic device as claimed in claim 10, wherein the electronic device comprises another second waterproof film facing the another first waterproof film, and a second loudspeaker received in the housing assembly, the another second waterproof film is attached on the second loudspeaker, the another first waterproof film, the inner housing, and the another second waterproof film cooperatively forming a fourth cavity.

12. The electronic device as claimed in claim 11, wherein the electronic device comprises a mounting member mounted to the housing assembly, the first and second loudspeakers are mounted on the mounting member by two mounting bases.

13. The electronic device as claimed in claim 12, wherein the electronic device comprises a circuit board caught between the inner housing and the mounting member, the circuit board defines a first opening and a second opening at the two opposite ends of the circuit board, the first loudspeaker is received in the first opening, and the second loudspeaker is received in the second opening.

14. The electronic device as claimed in claim 11, wherein the first and second waterproof films are made of synthetic resin or tarp, the first and second waterproof films define a plurality of micro-pores therein.
